(19) United States
(12) Patent Application Publication
(10) Pub. No.: US 2026/0243355 A1
(43) Pub. Date: Aug. 20, 2026

(54) PRESSURE-ASSISTED SEALING A CAGE GUIDED VALVE

(71) Applicant: Dresser, LLC, Houston, TX (US)

(72) Inventors: Justin Walter Betley, Raynham, MA (US); Keith Meneses, Andover, MA (US)

(21) Appl. No.: 19/053,893

(22) Filed: Feb. 14, 2025

(51) Int. Cl. F16K 5/16; F16K 5/04

(52) U.S. Cl. CPC F16K 5/162; F16K 5/04

(57) ABSTRACT

A valve trim configured for use in a flow control. These configurations may include a first seal, like a conical seal, that resides on top of a plug. This type of seal can expand under load to contact an inner surface of a cage. A second seal may reside inside of the plug, circumscribing a spindle that couples with an end of a valve stem. The first seal and the second seal can create internal seal points, for example, with the inner surface of the cage and with the outer surface of the spindle. These seal points improve performance of the flow control for use in applications that require devices that meet class V and related standards. In one implementation, the flow control may embody a flow-to-open device that is compatible with severe conditions, like high pressure or high temperature.

### BACKGROUND

Flow controls are important to many industries. Valves are a type of flow control that operators favor to regulate flow of material (or “process fluid”) on their process lines, in gas distribution networks, or any system that carries flowing material. In the field, these devices can regulate material flow with set parameters, or, in case of problems, release or shut-off flow altogether. These functions often require mechanical mechanisms for this purpose. The mechanisms may include an actuator that couples with a valve, which may have a closure member and a seat. The closure member may embody a plug, a ball, a butterfly valve, or like implement that can move to positions relative to the seat in response to fluid pressure. The actuator may provide a load on the closure member to regulate these positions, which in turn define flow of material through the device, including, for example, open positions that allow flow through the device and a closed position, where the closure member contacts the set to prohibit flow.

### SUMMARY

The subject matter of this disclosure relates to improvements to construction of valves and other flow controls. Of particular interest herein are embodiments of a valve trim that forms an internal seal, typically a metal-to-metal seal. These embodiments may find use in valves that operators prefer for extreme or severe service environments or like industrial applications. These valves may include Class V valves, for example, an “effectively zero-leakage” control valve. The standards for these types of valves limit leakage through the valve to a maximum, or no more than, 0.0005 ml of water per minute, per inch of port diameter, per PSI differential pressure as measured from an inlet port on the valve to an outlet port on the valve. The embodiments herein meet these standards, but also ensure that movement between parts of the valve remains repeatable and predictable.

### DRAWINGS

This specification refers to the following drawings:

FIG. 1 depicts a schematic diagram of an exemplary embodiment of a valve trim;

FIG. 2 depicts a schematic diagram of the valve trim of FIG. 1;

FIG. 3 depicts a perspective view from the top of an example of a seal for use in the valve trim of FIGS. 1 and 2;

FIG. 4 depicts an elevation view of the cross-section of the seal of FIG. 3;

FIG. 5 depicts an elevation view of the cross-section of an example of the valve trim of FIGS. 1 and 2;

FIG. 6 depicts a detail view of FIG. 5;

FIG. 7 depicts an elevation view of the cross-section of an example of the valve trim of FIGS. 1 and 2;

FIG. 8 depicts an elevation view of the cross-section of an example of the valve trim of FIGS. 1 and 2 in a flow control;

FIG. 9 depicts a detail view of FIG. 7;

FIG. 10 depicts the detail view of another example of the valve trim of FIG. 7;

FIG. 11 depicts a detail view of FIG. 10;

FIG. 12 depicts an elevation view of the cross-section of an example of the valve trim of FIGS. 1 and 2; and

FIG. 13 depicts an elevation view of the cross-section of an example of the valve trim of FIGS. 1 and 2.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” does not exclude the existence of additional embodiments or implementations that also incorporate the recited features.

### DESCRIPTION

The discussion now turns to describe features of the examples shown in the drawings noted above. These features provide internal seals on valves, including on control valves for class V shut-off in “flow-to-open” directions. These valves may find use in applications with high service temperatures. Steam conditioning valves, for example, are a type of flow-to-open device that are known to control steam pressure and temperature in process plants. Other embodiments are within the scope of this disclosure.

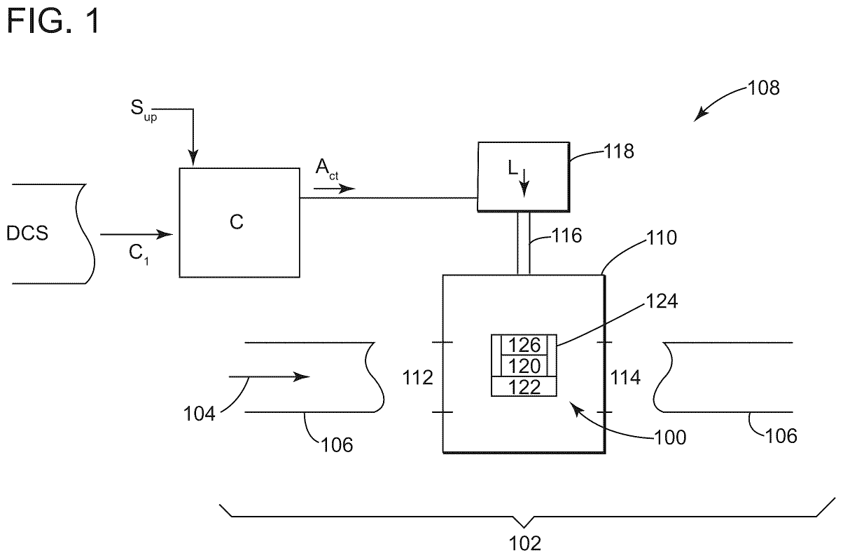

FIG. 1 depicts a schematic diagram of an exemplary embodiment of a valve trim 100. This embodiment is found in a distribution network 102, typically designed to carry material 104 through conduit 106. The valve trim 100 is part of a flow control 108 that may integrate into the network 102. As shown, the flow control 108 may have a superstructure 110 with openings (e.g., an inlet 112 and an outlet 114). A valve stem 116 may extend from an actuator 118 into the superstructure 110. The valve stem 116 may couple the actuator 118 with a plug 120 that can move relative to a seat 122 inside of a cage 124. In one implementation, the valve trim 100 may also include a seal unit 126 that resides in proximity to the plug 120 in the cage 124.

Broadly, the valve trim 100 may be configured to prevent leaks. These configurations may include one or more internal seals that are critical to meet “effectively zero leakage” in high temperature applications. Advantageously, the valve trim 100 may meet more stringent operating requirements without sacrifice to operating speed or responsiveness of device.

The distribution network 102 may be configured to deliver or move fluids. These configurations may embody vast infrastructure. Material 104 may comprise gases, liquids, solid-liquid mixes, or liquid-gas mixes, as well. The conduit 106 may include pipes or pipelines that often connect to pumps, boilers, and the like. The pipes 106 may also connect to tanks or reservoirs. In many facilities, this equipment forms complex networks to execute a process, like refining raw materials or manufacturing a product.

The flow control 108 may be configured to regulate flow of material 104 through the conduit 106 in these complex networks. These configurations may operate as a “flow-to-open” device that remains in a closed position until flow of material 104 reaches a specific flow rate or pressure. At this “set point,” the “flow-to-open” device will change to an open position that allows flow to exit, typically in response to rapid buildup of pressure upstream of the flow control 108. This open position discharges flow to alleviate pressure that could cause catastrophic damage to the flow control 108 or the distribution network 102, in general.

The “flow-to-open” device may be configured with a control mechanism to regulate flow of material 104. This control mechanism may include a controller C that is configured to process and generate signals. The controller C may connect to a control network (or “distributed control system” or “DCS”). The DCS may maintain operation of all devices on operator's process lines to ensure that material 104 flows in accordance with a process or meets certain process parameters. The DCS may generate a control signal C₁ that delivers operating parameters to the controller C. These operating parameters may describe or define operation of the flow control 108 to meet the process parameters, noted above. Operating hardware in the controller C may employ electrical and computing components (e.g., processors, memory, executable instructions, etc.). These components may also include electro-pneumatic devices that operate on incoming pneumatic supply signal Sᵤₚ, typically instrument air at process facilities. These components may generate an outgoing actuator control signal A_{ct} that is appropriate for the flow control 108 to regulate flow of material 104 downstream according to process parameters.

The superstructure 110 may be configured to support the controller C as well as other components of the flow control 108. These configurations may include a “valve body” and a “bonnet,” both often made of cast or machined metals. The valve body may have flanges or another connective feature at the openings 112, 114. Adjacent pipes 106 may connect or bolt to these flanges to allow material 104 to flow into and out of the device. The valve stem 116 may embody an elongated member, for example, a metal rod or shaft, often with a cross-section that is round or circular; but other shapes may find use in certain applications as well. The valve stem 116 may receive a load L from the actuator 118, typically a pneumatic actuator. In one implementation, the actuator control signal A_{ct} may pressurize the inside of the actuator 118. The pressure works with other components in the actuator 118 (like springs or diaphragms) to generate the load L to regulate position of the plug 120 relative to the seat 122. The cage 124 may embody a cylinder that surrounds the plug 120.

The seal unit 126 may be configured to engage with surfaces in the valve trim 100. These configurations may embody resilient elements that can deform under load, for example, by way of load L from the actuator 118 or by pressure of material 104 in the distribution network 102. For example, the resilient elements may “expand” to contact other surfaces to form internal seals that can prevent flow of material 104. The elements may also “contract” in absence of load, which may remove the internal seal. This feature benefits the design because the resilient elements will not interfere with transition of the plug 120 away from the seat 122, for example, in response to a rapid increase in pressure upstream of the plug 120.

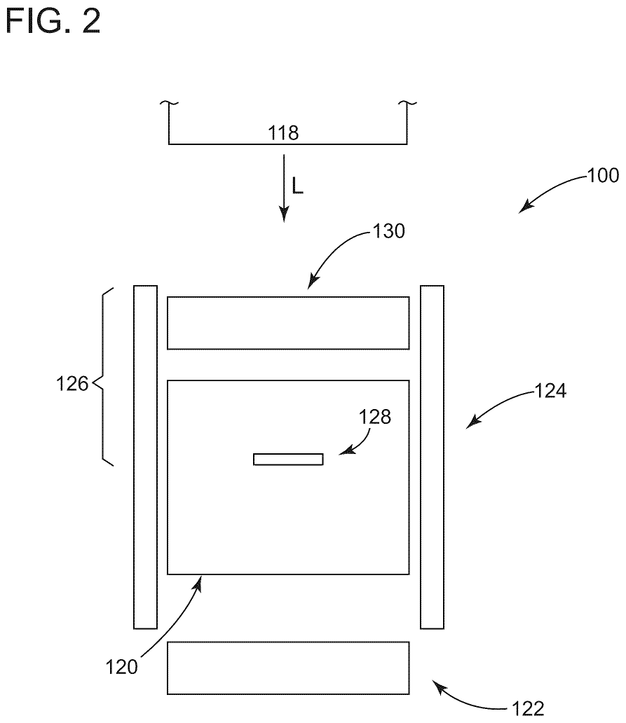

FIG. 2 depicts a schematic diagram of the valve trim 100 of FIG. 1 with parts removed for clarity. The seal unit 126 may include a pair of seals 128, 130. The seal 128 may reside inside of the plug 120. The seal 130 may reside outside of the plug 120. It is shown here in proximity to the top of the plug 120.

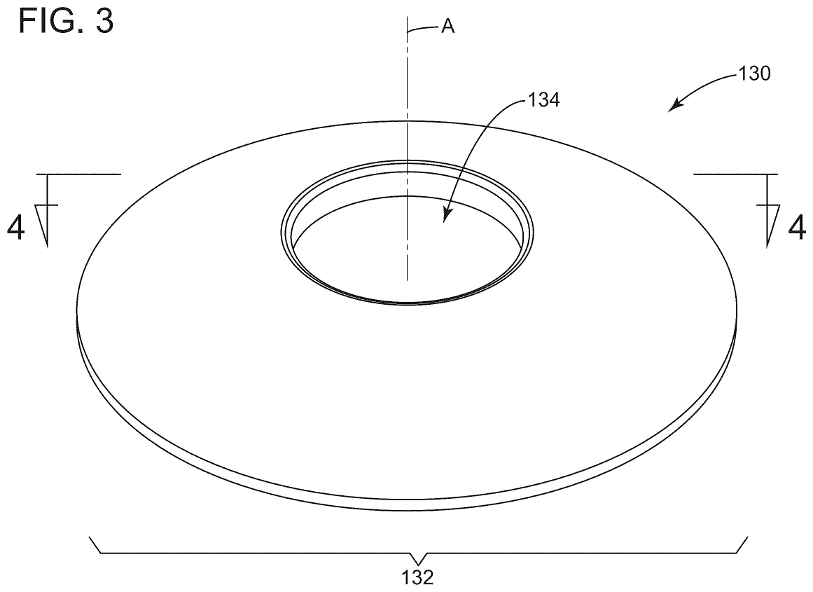

FIG. 3 depicts a perspective view of an example of structure for the seal 130 of FIG. 2. This structure may comprise a body 132 that is round or circular with a central axis A. It may comprise materials, like steel or stainless steel, that are compatible with conditions that subsist on the flow control 108 (FIG. 1). These conditions may require materials that can withstand high or low temperatures, high pressures, materials with caustic or hazardous properties, or any combination thereof. In one implementation, the body 132 may have geometry that is cone-like or adopts a conical shape. This geometry may have a central opening 134 that is concentric with the central axis A.

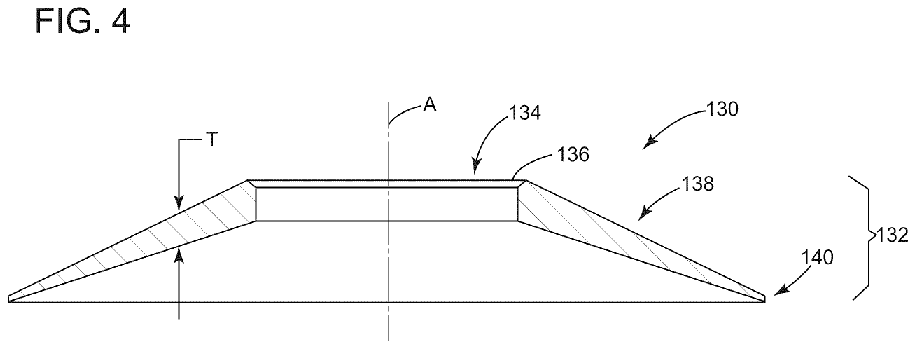

FIG. 4 depicts an elevation view of the cross-section of the seal 130 of FIG. 3. The central opening 134 may have an inner surface that terminates at an upper inner edge 136, shown here to have geometry that is a round or has a radius. Side 138 may slope from the inner edge 136 towards a peripheral edge 140. The side 138 may have a thickness T, which may decrease in this direction as well; however, in other examples, the thickness T may remain constant or increase. These features provide the body 132 with resilient or spring-like properties.

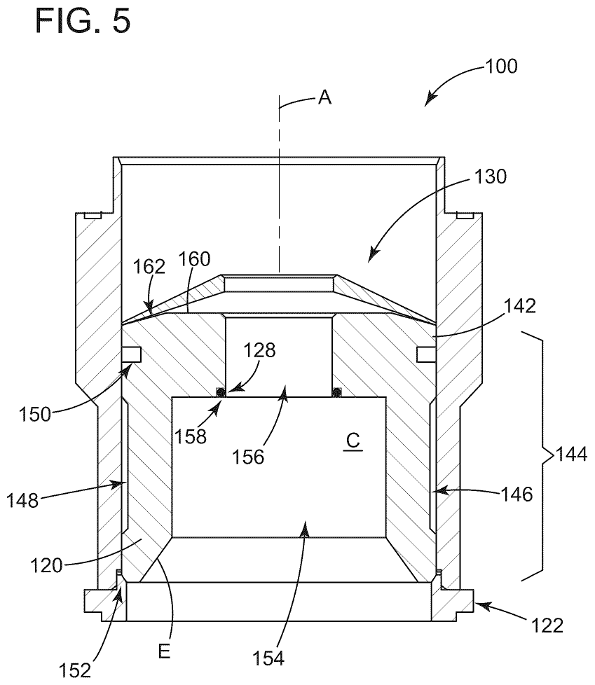

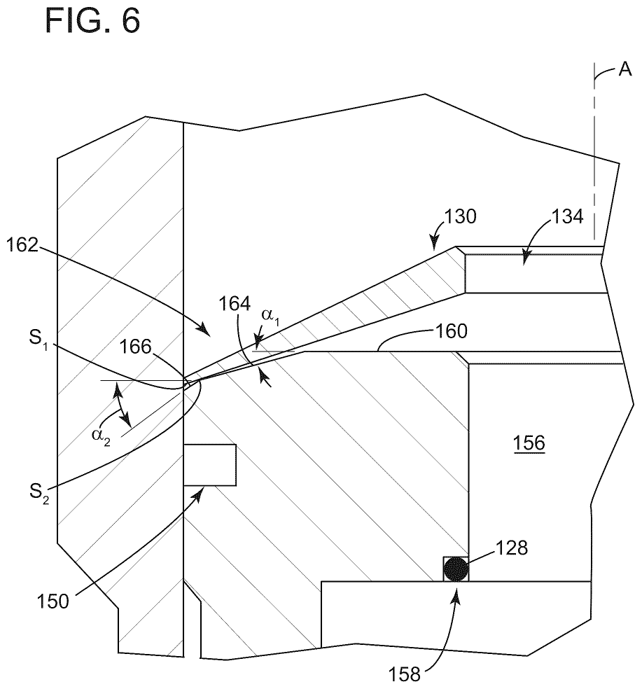

FIG. 5 depicts an elevation view of the cross-section of exemplary structure for the valve trim 100 of FIG. 1. The plug 120 may have a plug body 142 with geometry that forms a cylinder 144 with an outer surface 146 and a center axis, also identified by A because it aligns with the central axis A of the body 132. Grooves 148, 150 may penetrate the outer surface 146 and circumscribe the periphery of the cylinder 144. At the bottom, the cylinder 144 may have an outer chamfered edge 152 that matches geometry found on the seat 122. This geometry may create a tight, metal-to-metal seal, for example, when the plug 120 contacts the seat 122 to prevent flow of material 104 (FIG. 1) through the flow control 108 (FIG. 1). As also shown, the cylinder 144 may include a first bore 154 that extends from the bottom, forming a cavity C inside of the plug 120. The first bore 154 may have an inner chamfered edge E, for example, a countersink; but this feature may not always be required in the design. A second bore 156 may extend from the bottom of the cavity C through the top of the cylinder 144. In one implementation, the seal 128 may reside in a counterbore 158 that is concentric with the second bore 156. The seal 130 may reside in proximity to a surface 160 at the top of the cylinder 144. The surface 160 may have a portion 162 that tapers or slopes towards the outer surface 146. As best shown in the detail of FIG. 6, the portion 162 may include two sections 164, 166 that taper outwardly at two different angles α₁, α₂.

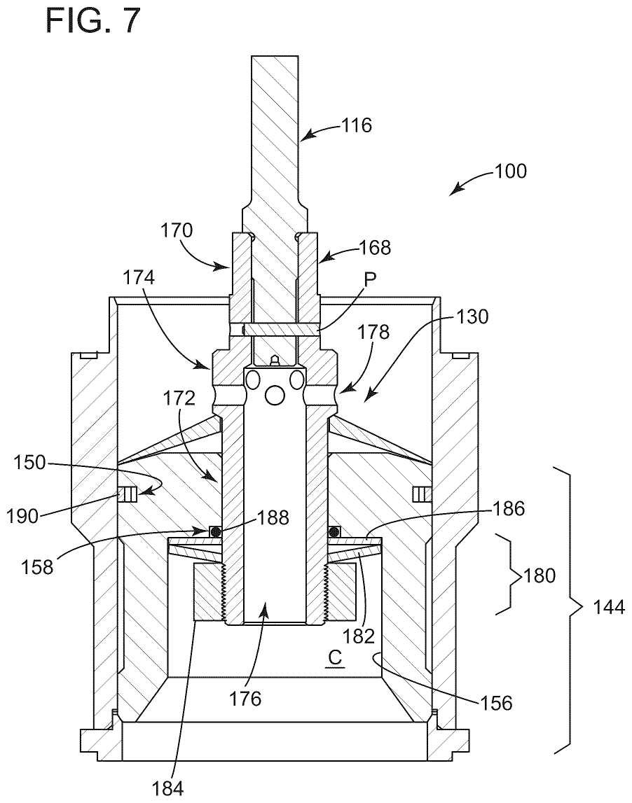

FIG. 7 depicts an elevation view of the cross-section of additional structure for the valve trim 100 of FIG. 1. The valve stem 116 may couple with a spindle 168, for example, using a pin P or other fastening technique (e.g., threaded screw, threaded bolt, etc.). The spindle 168 may have a diameter that varies to form an upper portion 170, a lower portion 172, and a shoulder portion 174 formed therebetween. The lower portion 172 may extend through both the central opening 134 (FIG. 6) of the seal 130 and the second bore 156 of the cylinder 144. This arrangement may locate an end of the spindle 168 in the cavity C. In one implementation, the spindle 168 may include a flow path that can allow flow of material 104. This flow path may include an axial bore 176 and a perpendicular or crosswise bore 178. As also shown, the valve trim 100 may include a retaining assembly 180 that may secure to the end of the spindle 168 to couple the plug 120 to the valve stem 116. The retaining assembly 180 may include a resilient member 182, like a Belleville washer, and a nut 184 that threads onto corresponding threads found on the end of the spindle 168. A flat washer 186 may interpose between the Belleville washer 182 and the bottom of the cavity C. The flat washer 186 may maintain the seal 128 (FIG. 6), shown here as a metal “C-seal” 188, in the counterbore 158. The metal “C-seal” 188 may circumscribes the spindle 168. A seal ring 190 may reside in the groove 150 and circumscribe the cylinder 144. The seal ring 190 may comprise materials that meet conditions or requirements for the application of the flow control 108 (FIG. 1). These materials may include Teflon; however, graphite or metal piston ring seals may find use as the seal ring 190 in higher temperature applications.

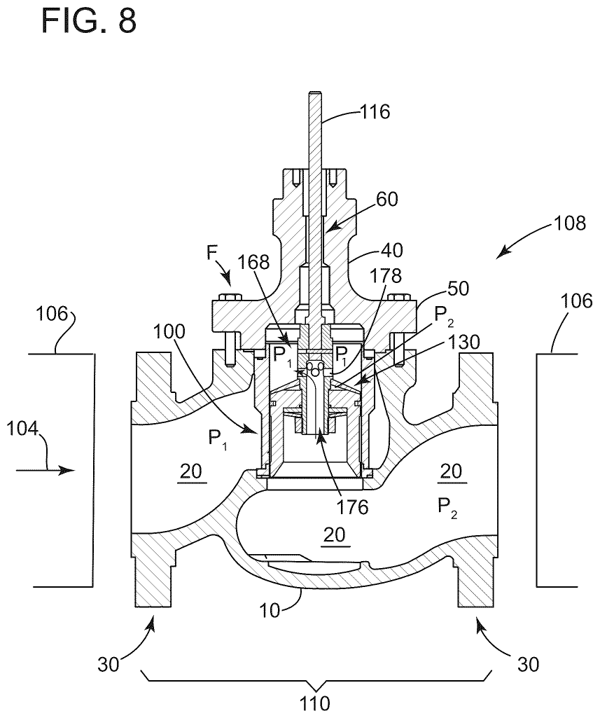

FIG. 8 depicts an elevation view of the cross-section of the valve trim 100 of FIG. 7 in exemplary structure for the flow control 108 of FIG. 1. The valve body or casing 10 of the superstructure 110 may form flow paths 20 that terminate at flanged openings 30. The flow paths 20 may receive material 104 from adjacent conduit 106 that attach to the casing at the flanged openings 30. The bonnet 40 of the superstructure 110 may include a bonnet flange 50 that couples with the casing 10. Fasteners F, like nuts and bolts, may penetrate through openings in the bonnet flange 50 to secure the bonnet 40 to the casing 10. The valve stem 116 may extend through the bonnet 40. In one implementation, packing 60 may fit over the valve stem 116. The packing 60 is useful to allow movement of the valve stem 116 but prevent the flow fugitive emissions from the flow control 108. As noted herein, the flow control 108 may embody a “flow-to-open” shutoff valve. The valve trim 100 may manage pressure across an upstream side and a downstream side of the valve trim 100, often where upstream pressure P₁ is larger than downstream pressure P₂. In one implementation, the bores 176,178 in the spindle 168 may allow upstream pressure P₁ into space above the seal 130.

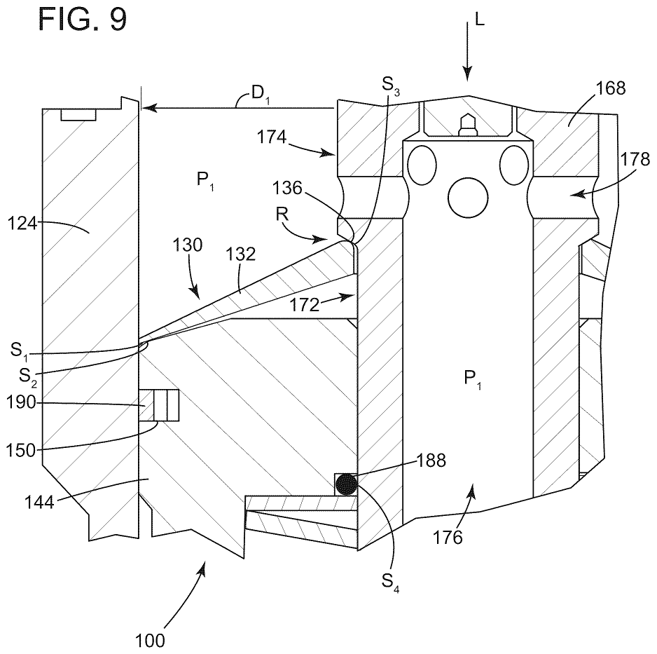

FIG. 9 depicts a detail view of the valve trim 100 of FIG. 8. The geometry of the body 132 of the seal 130 may allow it to expand under load L, which increases its outer diameter D₁ to contact the inner surface of the cage 124. This feature may create a first seal point S₁ between the body 132 and the inner surface of the cage 124. A second seal point S₂ may also form between the body 132 and the top of the cylinder 144 (at a junction that forms between angles α₁, α₂ (see FIG. 6). The spindle 168 may include a rounded interface R between the portions 172, 174 to receive the inner edge 136 of the seal 130. The rounded interface R may have a radius that is different from the radius of the rounded inner edge 136, which may promote contact between these two parts to create a third seal point S₃. The C-seal 188 may create a fourth seal point S₄ with the outer surface of the spindle 168.

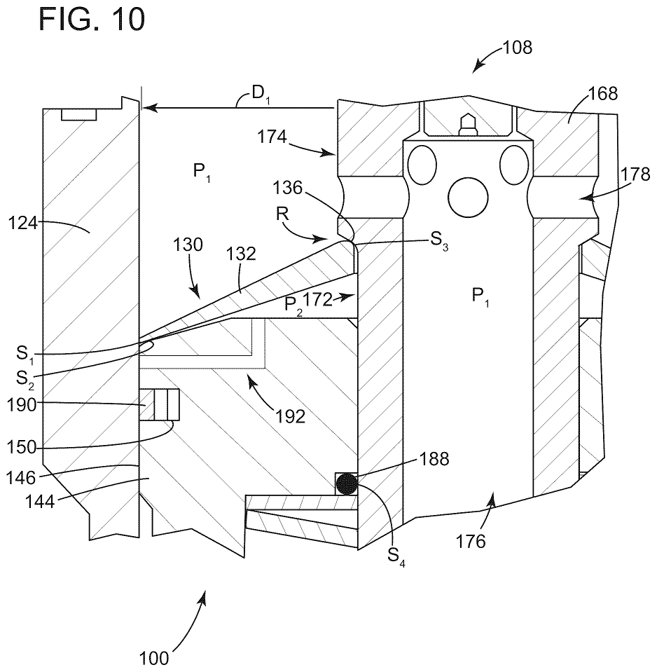

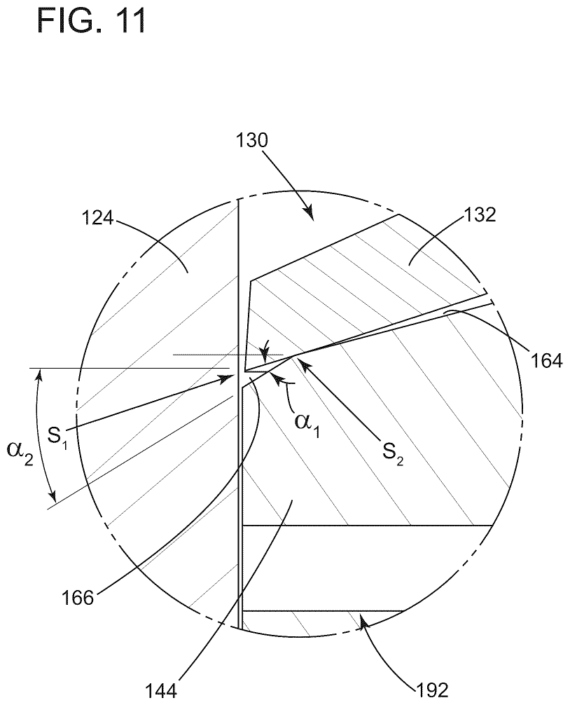

FIGS. 10 and 11 depict details view of another example of the valve trim 100 of FIG. 7. The cylinder 144 may include a flow path 192 that extends from the outer surface 146 of the cylinder 144 to the top of the cylinder 144. The flow path 192 may allow flow of material 104 from space between the outer surface 146 of the cylinder 144 and the inner surface of the cage 124. As shown in FIG. 11, the body 132 of the seal 130 is spaced apart from the inner surface of the cage 124 at the first seal point S₁. The second seal point S₂ forms at a junction that forms between angles α₁, α₂. In use, the flow path 192 may render the second seal point S₂ ineffective because it allows downstream pressure P₂ into space between the seal 130 and the top of the cylinder 144. However, the third seal point S₃ and the fourth seal point S₄ isolate upstream pressure P₂. This feature creates a seating force F₁, or “pressure-assist” force, that results from a pressure differential that forms above and below the seal 130 because, in the closed position of the valve, the upstream pressure P1 is greater than the downstream pressure P2. The seating force F₁ further engages the seal 130 to improve or maintain the first seal point S₁ and, thus, prevent leaks or leakage from the valve trim 100, even in the absence of (or reduction in) load L.

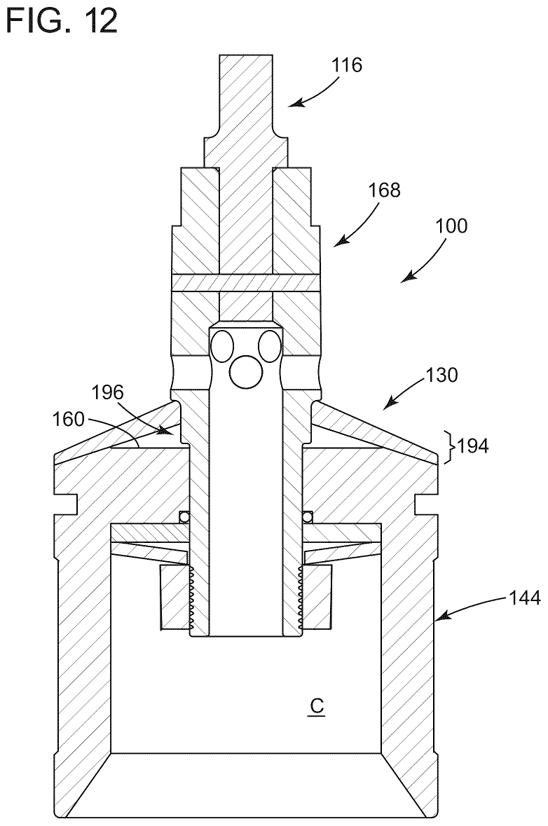

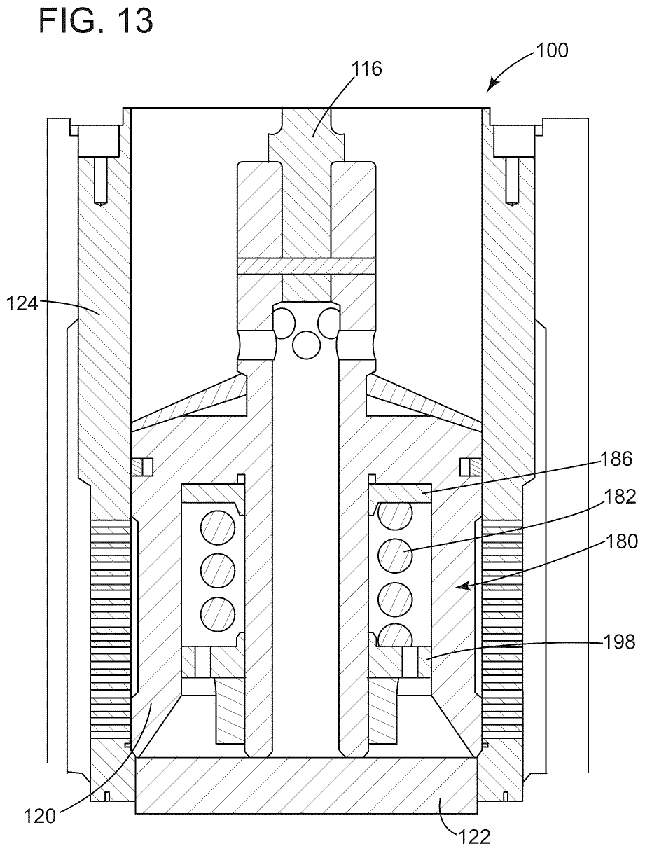

FIGS. 12 and 13 depict elevation views of the cross-section for other examples of the valve trim 100 of FIG. 1. In FIG. 12, the valve trim 100 may include a hardstop 194 to prevent “overdrive” that can cause the seal 130 to flatten more than desired. The hardstop 194 may embody part of the spindle 168, for example, a second shoulder portion 196 in proximity to the top of the cylinder 144. The hardstop 194 contacts the surface 160 of the cylinder 144 to prevent travel of the spindle 168 further into the cavity C of the plug body 120. In FIG. 13, the resilient member 182 may embody a coil spring (in lieu of the Belleville washer (FIG. 7)). The retaining assembly 180 may also include a flat washer 198.

Considering the foregoing, the improvements noted herein outfit valves for use in applications that require class V shut-off in “flow-to-open” direction. These improvements create seal points that provide additional or supplementary sealing to meet these standards. However, the underlying hardware that creates these seal points do not interfere with operation of the valve to open, as necessary, in response to changes in pressure or other conditions that may require the valve to change from its normally closed position to its open position.

This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A valve, comprising:
a seat;
a cage having an end in proximity to the seat;
a plug disposed in the cage and moveable relative to the seat, the plug having a center axis, a top, a bottom in proximity to the seat, and an outer surface, the plug comprising a flow path terminating at a first opening on the top and a second opening on the outer surface; and
a first seal disposed on the top of the plug, the first seal having a seal body with a peripheral outer edge,
wherein the body is configured to expand under a load so that the outer peripheral edge contacts the cage to create a first seal point.

2. The valve of claim 1, wherein the first opening of the flow path is disposed under the first seal.

3. The valve of claim 1, wherein the first opening of the flow path is disposed closer to the center axis of the plug than a second seal point that the body forms with the top of the plug.

4. The valve of claim 1, wherein the second opening is disposed proximate the top of the plug.

5. The valve of claim 1, further comprising:
a seal ring circumscribing the outer surface of the plug,
wherein the second opening is disposed between the seal ring and the top of the plug.

6. The valve of claim 1, further comprising:
a spindle extending through the first seal,
wherein the spindle contacts the first seal to create a second seal point.

7. The valve of claim 1, further comprising:
a spindle extending through the first seal,
wherein the spindle has a shoulder that contacts the first seal to create a second seal point.

8. The valve of claim 1, further comprising:
a spindle extending through the first seal,
wherein the spindle has a shoulder with a rounded interface that contacts the first seal to create a second seal point.

9. The valve of claim 1, further comprising:
a valve stem;
a spindle coupled to one end of the valve stem, the spindle extending through the first seal and into the plug; and
a second seal circumscribing the spindle inside of the plug.

10. The valve of claim 9, wherein the second seal comprises a metal C-seal disposed in the plug and circumscribing the center axis of the plug.

11. The valve of claim 1, further comprising:
a metal C-seal disposed in the plug and circumscribing the center axis of the plug; and
a spindle extending through the metal C-seal; and
a valve stem coupled to one end of the spindle.

12. A valve, comprising:
valve trim comprising:
a moveable plug having a center axis, a top, and an outer surface, the plug comprising a flow path terminating at a first opening on the top and a second opening on the outer surface; and
a first seal disposed on the top of the plug, the first seal having a conical shape.

13. The valve of claim 12, further comprising:
a seal ring circumscribing the outer surface of the plug,
wherein the second opening is disposed between the seal ring and the top of the plug.

14. The valve of claim 12, further comprising:
a second seal disposed inside a cavity in the plug.

15. The valve of claim 14, wherein the second seal comprises a metal C-seal.

16. The valve of claim 11, further comprising:
a valve stem;
a spindle coupled to an end of the valve stem, the spindle extending through the first seal into a cavity in the plug; and
a second seal disposed in the plug and circumscribing the spindle.

17. A flow-to-open valve, comprising:
valve trim comprising:
a cage;
a plug coupled to the spindle and moveable within the cage,
a first seal disposed on top of the plug,
wherein the plug is configured to allow flow of fluid from a first location between the plug and the cage to a second location under the first seal.

18. The flow-to-open valve of claim 17, further comprising:
a second seal disposed inside of the plug.

19. The flow-to-open valve of claim 17, further comprising:
a valve stem; and
a spindle coupled to an end of the valve stem, the spindle extending through the first seal and into the plug,
wherein the first seal is configured to create a first seal point with an inner surface of the cage, a second seal point with a surface on the top of the plug, and a third seal point with the spindle.

20. The flow-to-open valve of claim 17, further comprising:
a valve stem; and
a spindle coupled to an end of the valve stem, the spindle extending through the first seal and into the plug,
wherein the first seal is configured to create a first seal point with an inner surface of the cage, a second seal point with a surface on the top of the plug, and a third seal point with the spindle, and wherein the second seal is configured to create a fourth seal point with the spindle.
